(19) United States
(12) Patent Application Publication
(10) Pub. No.: US 2009/0064344 A1
(43) Pub. Date: Mar. 5, 2009

(54) METHOD AND APPARATUS FOR MANAGING DIGITAL RIGHTS MANAGEMENT RIGHTS OBJECTS

(75) Inventors: HYOUNG-SHICK KIM, Suwon-si (KR); Won-Seok Kwon, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Gyeonggi-do (KR)

(21) Appl. No.: 12/200,050

(22) Filed: Aug. 28, 2008

Related U.S. Application Data
(60) Provisional application No. 60/968,650, filed on Aug. 29, 2007.

(30) Foreign Application Priority Data
Nov. 30, 2007 (KR) 10-2007-0123634

(51) Int. Cl. G06F 21/00

(52) U.S. Cl. 726/27

(57) ABSTRACT

Provided are a method and apparatus for managing digital rights management (DRM) rights objects, and more particularly, to a method and apparatus for downloading and managing DRM rights objects by accessing a device, which does not support DRM technology, using a universal plug and play (UPnP) network. The method includes requesting a media server, which has downloaded specified content, to provide meta information of the content; determining whether to download a rights object for the content based on the meta information of the content; requesting an approval for the download of the rights object if it is determined to download the rights object; and providing the downloaded rights object to the media server.

This application claims priority from U.S. Provisional Application No. 60/968,650, filed on Aug. 29, 2007 in the United States Patent and Trademark Office, and Korean Patent Application No. 10-2007-0123634, filed on Nov. 30, 2007 in the Korean Intellectual Property Office, the disclosures of which are incorporated herein by reference in their entirety.

### BACKGROUND OF THE INVENTION

1. Field of the Invention

Methods and apparatuses consistent with the present invention relate to managing digital rights management (DRM) rights objects, and more particularly, to downloading and managing DRM rights objects by accessing a device, which does not support DRM technology, using a Universal Plug and Play (UPnP) network.

2. Description of the Related Art

The growth of the Internet and the development of multimedia technology are making it easier to distribute and obtain digital content. However, if there is no way to protect the copyright on the digital content, these technologies can become mediums for illegally distributing the digital content.

Digital rights management (DRM) is a technology that securely distributes and disseminates content and controls the use of the content according to a policy in order to protect the copyrights of content owners and prevent the illegal use of the content by unauthorized users. DRM allows unlimited access to encrypted digital content by anyone. However, a license is required to decrypt and reproduce the encrypted digital content. Therefore, DRM can protect digital content more effectively than other methods of protection found in the related art.

DRM functions are largely divided into the following: the protection of digital content, the management of usage rules of the digital content, and the management of a billing system. In order to protect digital content, DRM technology encrypts the digital content and thus prevents the illegal distribution or use of the digital content in all stages (i.e., creation, distribution, use, and disposal) of its life cycle. In addition, DRM technology enables only an authorized user with an encryption key to decrypt and use encrypted content. Therefore, even if the encrypted content is illegally distributed, it cannot be used without the encryption key.

Recently, DRM technology has adopted domain technology to support a domain function which enables DRM content to be freely shared within a domain of a user. A major example of the DRM technology that supports the domain function includes Open Mobile Alliance (OMA) DRM 2.0.

OMA DRM 2.0 enables a device in a domain to reproduce content for the domain without particular restrictions and transmit the content to another device in the domain. That is, an OMA DRM 2.0 compatible device in a domain can download DRM content and a rights object using an OMA DRM agent and share the downloaded DRM content and rights object with another device in the domain.

Devices in a domain form a UPnP network. In the UPnP network, the devices may be classified as a media server, which stores and transmits content, a media player which reproduces the content, and a control point which controls the media server. Since the DRM technology is associated with codec, it is usually applied only to the media player.

Related art OMA DRM technology is based on an assumption that a browser, a DRM agent, and a download agent are implemented in the same apparatus. Therefore, the related art technology does not require devices to share functions through a network. However, it is undesirable in terms of complexity and cost to implement a browser, a DRM agent and a download agent in each home network device.

Korean Patent Publication No. 2007-063000 (“Method for Distributing Content to a Mobile Device with Digital Rights and Mobile Device Therefor”) discloses a method of distributing content from a computer system to a mobile device. The method includes: creating in the mobile device a rights object request file including information necessary for forming a rights object response file including a nonce associated with the mobile device; storing the rights object request file in a folder; storing a copy of the nonce in the mobile device; reading in the computer system the rights object request file from the folder; based on a protected content file, forming in the computer system a rights object file using said information in the rights object request file and an encrypted content file; storing the rights object file and the encrypted content file in the folder; retrieving the rights object file in the mobile device; and decrypting the associated encrypted content file using the rights object file and the stored copy of the nonce. However, the above invention fails to mention a technology which enables access to a device that does not support the DRM technology.

### SUMMARY OF THE INVENTION

The present invention provides a method and apparatus for downloading and managing DRM rights objects by accessing a device which does not support DRM technology, using a UPnP network.

According to an aspect of the present invention, there is provided a method of managing DRM rights objects. The method includes requesting a media server, which has downloaded specified content, to provide meta information of the content; determining whether to download a rights object for the content based on the meta information of the content; requesting an approval for the download of the rights object when it is necessary to download the rights object; and providing the downloaded rights object to the media server.

According to another aspect of the present invention, there is provided an apparatus for managing DRM rights objects. The apparatus includes a meta information request unit which requests a media server, which has downloaded specified content, to provide meta information of the content; a determination unit which determines whether to download a rights object for the content based on the meta information of the content; and a rights object managing unit which downloads the rights object from a rights issuer when the determination unit determines to download the rights object and which provides the downloaded rights object to the media server.

### BRIEF DESCRIPTION OF THE DRAWINGS

The above and other aspects of the present invention will become more apparent by describing in detail exemplary embodiments thereof with reference to the attached drawings, in which:

FIG. 1 is a diagram illustrating a system for managing DRM rights objects according to an exemplary embodiment of the present invention;

FIG. 2 is a block diagram of a media server included in the system of FIG. 1;

FIG. 3 is a block diagram of a control point included in the system of FIG. 1;

FIG. 4 is a flowchart illustrating operations performed by a content provider server and the media server, wherein the operations are included in a method of managing DRM rights objects according to an exemplary embodiment of the present invention;

FIG. 5 is a flowchart illustrating a process in which the control point downloads a rights object to the media server, wherein the process is included in the method for managing rights objects according to the exemplary embodiment of the present invention; and

FIG. 6 is a flowchart illustrating a process in which the control point deletes an invalid rights object from the media server, wherein the process is included in the method of managing DRM rights objects according to the exemplary embodiment of the present invention.

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinafter, exemplary embodiments of the present invention will be described with reference to the attached drawings.

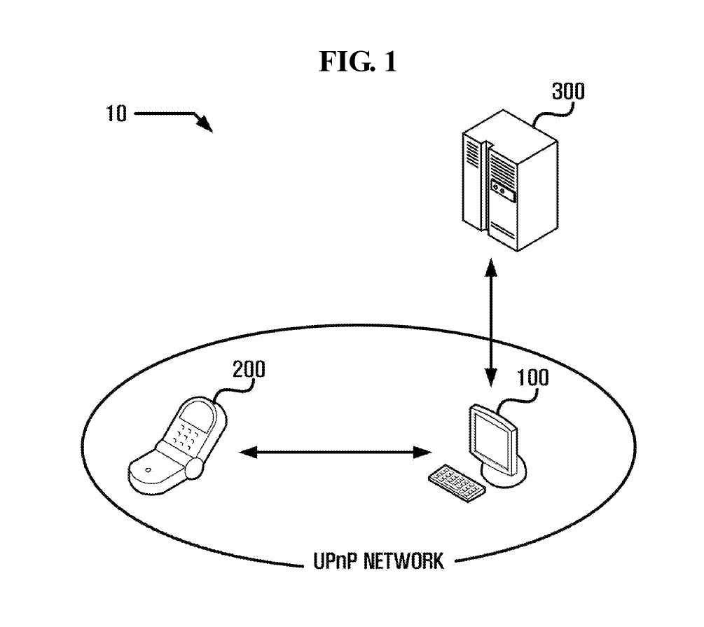

FIG.1 is a diagram illustrating a system 10 for managing DRM rights objects according to an exemplary embodiment of the present invention. Referring to FIG. 1, the system 10 includes a media server 100, a control point 200, and a content provider server 300. The media server 100 and the control point 200 exist on a universal plug and play (UPnP) network.

The content provider server 300 includes a presentation server, a download server, and a state report server.

The presentation server is a web server which helps a user to browse or retrieve DRM content. In addition, the presentation server helps the user to select content and pay for the selected DRM content. After the user pays for the selected DRM content, the presentation server transmits a download descriptor to an apparatus of the user or the media server 100. The download descriptor defines content information (such as type, object uniform resource identifier (URI) and rights-issuer uniform resource locator (URL)) required to download the selected DRM content and instructions for a download agent.

The download server provides a download service for the DRM content selected by the user. In addition, the download server transmits the DRM content or a rights object for the DRM content to the apparatus of the user or the media server 100.

The state report server collects reports on the download state information and the installation and use information of the DRM content from the apparatus of the user or the media server 100.

The media server 100 receives content (or DRM content) from the content provider server 300 and stores the received content. In addition, the media server 100 includes a UPnP MediaServer component and functions as a server of a home network such as the UPnP network. The media server 100 may be a personal computer (PC), a settop box, a digital television, a game player, or the like. The media server 100 according to the present embodiment does not support OMA DRM 2.0.

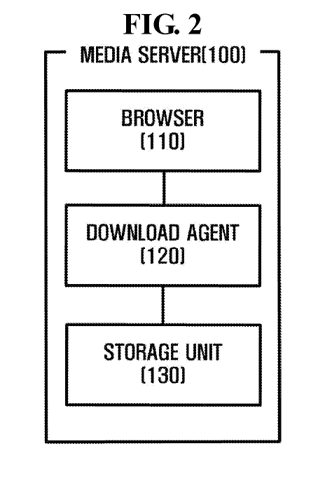

As shown in FIG. 2, the media server 100 includes a browser 110, a download agent 120 and a storage unit 130 to manage and download content. The media server 100 will be described in more detail later with reference to FIG. 2.

The control point 200 controls devices on the UPnP network through the media server 100 and includes a UPnP ControlPoint component. The control point 200 may be included in the media server 100 or a media player. Thus, the control point 200 may be implemented as an independent hardware device such as a remote control. When the control point 200 is included in the media player, the control point 200 may be a mobile phone, a personal data assistant (PDA), an MP3 media player, a portable media player (PMP), or the like. The control point 200 according to the present exemplary embodiment supports OMA DRM 2.0.

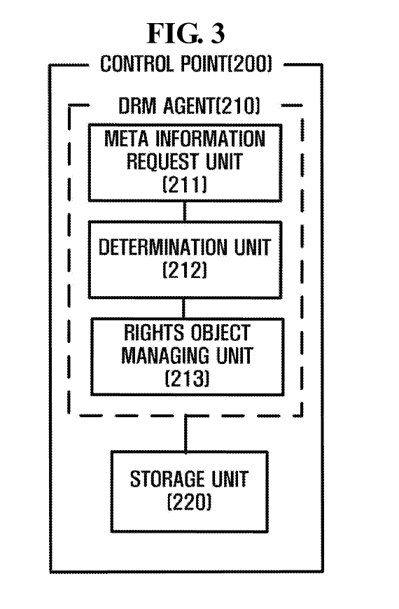

As shown in FIG. 3, control point 200 includes a DRM agent 210 and a storage unit 220 to manage DRM rights objects. The control point 200 will be described in more detail later with reference to FIG. 3.

The term ‘unit’, as used herein, means, but is not limited to, a software or hardware component, such as a Field Programmable Gate Array (FPGA) or Application Specific Integrated Circuit (ASIC), which performs certain tasks. A unit may advantageously be configured to reside on the addressable storage medium and configured to execute on one or more processors. Thus, a unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units may be combined into fewer components and units or further separated into additional components and units.

FIG. 2 is a block diagram of the media server 100 included in the system 10 of FIG. 1.

Referring to FIG. 2, the browser 110 accesses the content provider server 300 and browses DRM content. Then, the browser 110 selects desired DRM content from the browsed DRM content and pays for the selected DRM content. In addition, the browser 110 receives a download descriptor from the content provider server 300.

The download agent 120 downloads the download descriptor received from the content provider server 300 to obtain content information (such as type, object URI and rights-issuer URL) required to download the selected DRM content.

In addition, the download agent 120 receives the selected DRM content from the content provider server 300 using the obtained content information. Here, the download agent 120 of the media server 100 requests the content provider server 300 to provide the selected DRM content using the object URI.

The storage unit 130 stores the download descriptor and the DRM content downloaded from the content provider server 300 and a DRM rights object received from the control point 200.

FIG. 3 is a block diagram of the control point 200 included in the system 10 of FIG. 1. For the purposes of FIG. 3, it is assumed that the control point 200 is included in a media player. Thus, DRM content can be reproduced.

The DRM agent 210 controls the use of DRM content according to rights objects which are required to reproduce the DRM content, and manages the rights objects. The DRM agent 210 includes a meta information request unit 211, a determination unit 212, and a rights object managing unit 213.

The meta information request unit 211 requests the media server 100, which has downloaded specified content, to provide meta information of the downloaded content in order to determine whether to download a rights object for the content.

In addition, the meta information request unit 211 requests the media server 100 to provide meta information of a rights object stored therein in order to determine the validity of the rights object.

The determination unit 212 determines whether to download the rights object based on the meta information of the content provided by the media server 100. In addition, the determination unit 212 determines the validity of the rights object stored in the media server 100 based on the meta information of the rights object provided by the media server 100. Here, the validity of the rights object may be determined by whether the rights object has expired.

When the determination unit 212 determines that the rights object needs to be downloaded, the rights object managing unit 213 requests a rights issuer to allow the download of the rights object and, if allowed, downloads the rights object. Then, the rights object managing unit 213 provides the downloaded rights object to the media server 100. Here, the rights object managing unit 213 transmits the URI of the downloaded rights object to the media server 100, so that the media server 100 can download the rights object using the received URI.

For example, the DRM agent 210 determines whether to download a rights object required to reproduce DRM content, which has been downloaded to the media server 100, using meta information of the DRM content. When the DRM agent 210 determines to download the rights object, it obtains information (such as a DRM content identifier (ID) and purchase records), which is required to download the rights object, from the media server 100. Using the obtained information, the DRM agent 210 requests the rights issuer to allow the download of the rights object and, if allowed, downloads the rights object.

In addition, the DRM agent 210 determines the validity of a rights object stored in the media server 100 based on meta information of the rights object. When the DRM agent 210 determines that the rights object is invalid (for example, when the rights object has expired), the rights object is deleted.

The storage unit 220 stores rights objects downloaded from the rights issuer. In addition, the storage unit 220 stores meta information of DRM content and meta information of rights objects.

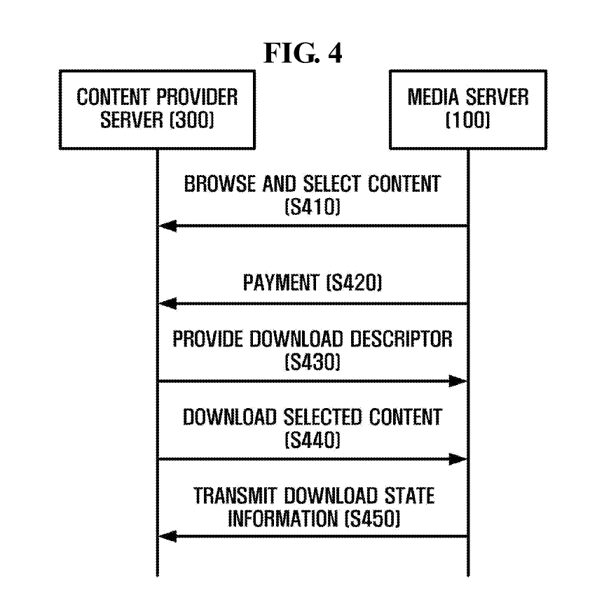

FIG. 4 is a flowchart illustrating operations performed by the content provider server 300 and the media server 100, wherein the operations are included in a method of managing DRM rights objects according to an exemplary embodiment of the present invention. In FIG. 4, a process in which the media server 100 downloads DRM content from the content provider server 300 will be described.

Referring to FIG. 4, the browser 110 of the media server 100 accesses the content provider server 300, browses DRM content, and selects desired DRM content (operation S410). Then, the browser 110 pays for the selected DRM content (operation S420).

Next, the content provider server 300 provides a download descriptor to the media server 100 (operation S430). Accordingly, the download agent 120 of the media server 100 obtains content information (such as type, object URI and rights-issuer URL) required to download the selected DRM content using the download descriptor.

Next, the download agent 120 of the media server 100 downloads the selected DRM content from the content provider server 300 using the obtained content information (operation S440).

Then, the media server 100 transmits download state information, which informs whether the selected DRM content has been successfully downloaded, to the content provider server 300 (operation S450).

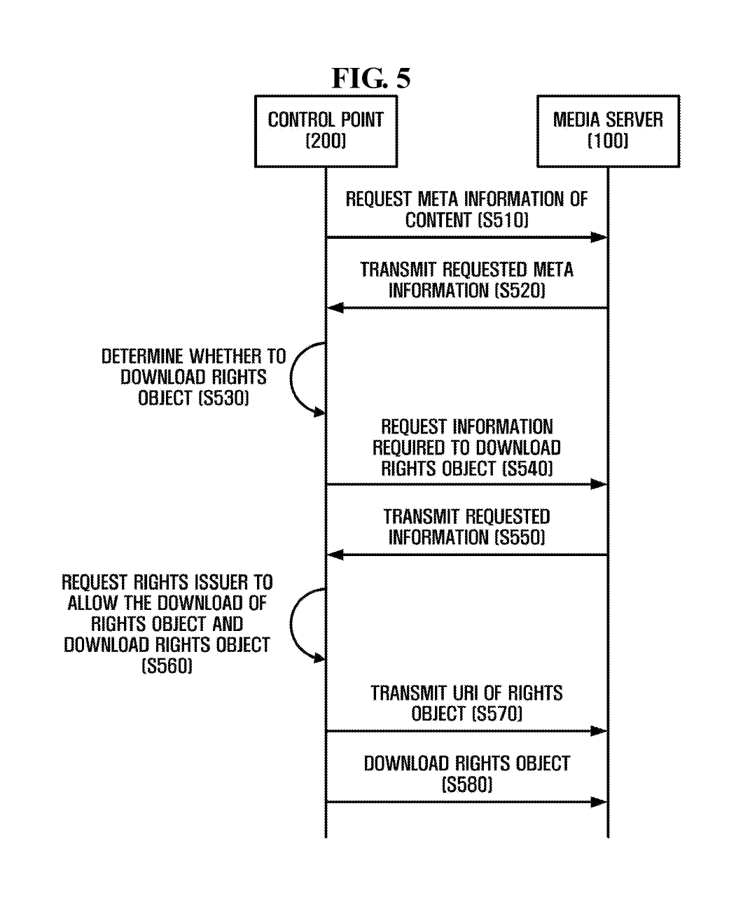

FIG. 5 is a flowchart illustrating a process in which the control point 200 downloads a rights object to the media server 100, wherein the process is included in the method for managing rights objects according to the exemplary embodiment of the present invention.

Referring to FIG. 5, the DRM agent 210 of the control point 200 requests the media server 100 to provide meta information of specified DRM content in order to determine whether to download a rights object required to reproduce the DRM content (operation S510). Accordingly, the media server 100 retrieves the meta information of the DRM content requested by the control point 200 and transmits the retrieved meta information to the control point 200 (operation S520).

Then, the DRM agent 210 of the control point 200 determines whether to download the rights object, which is required to download the DRM content, based on the meta information of the DRM content received from the media server 100 (operation S530).

When determining to download the rights object, the DRM agent 210 of the control point 200 requests the media server 100 to provide information (such as DRM content ID and purchase records) required to download the rights object (operation S540). Accordingly, the media server 100 retrieves the information requested by the control point 200 and transmits the retrieved information to the control point 200 (operation S550).

Next, the DRM agent 210 requests a rights issuer to allow the download of the rights object using the received information and downloads the rights object if allowed (operation S560). Here, the DRM agent 210 of the control point 200 downloads the rights object from the rights issuer using a rights object acquisition protocol (ROAP).

Then, the control point 200 transmits the URI of the downloaded rights object to the media server 100 using an ‘X_ImportRightObjectURI’ method (operation S570). Accordingly, the media server 100 accesses the control point 200 using the URI of the rights object, which is received from the control point 200, and downloads the rights object (operation S580). That is, the control point 200 including the DRM agent 210 can be connected to the media server 100 which does not support DRM technology, so that the media server 100 can download a DRM rights object from the control point 200.

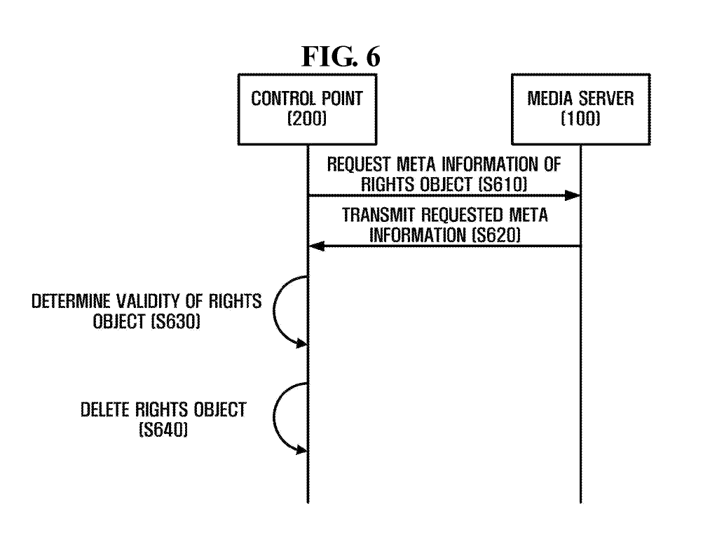

FIG. 6 is a flowchart illustrating a process in which the control point 200 deletes an invalid rights object from the media server 100, wherein the process is included in the method of managing DRM rights objects according to the exemplary embodiment of the present invention.

Referring to FIG. 6, the DRM agent 210 of the control point 200 requests the media server 100 to provide meta information of a specified rights object in order to determine the validity of the rights object (operation S610). Accordingly, the media server 100 retrieves the meta information of the rights object requested by the control point 200 and transmits the retrieved meta information to the control point 200 (operation S620).

Next, the DRM agent 210 of the control point 200 determines the validity of the rights object based on the meta information of the rights object received from the media server 100 (operation S630). Here, the validity of the rights object may be determined by whether the rights object has expired.

When the DRM agent 210 determines that the rights object is invalid, the control point 200 deletes the invalid rights object, which is stored in the media server 100, using an ‘X_DeleteRightObject’ method (operation S640). That is, the control point 200 including the DRM agent 210 can access the media server 100, which does not support DRM technology, and check and manage the validity of rights objects provided to the media server 100.

As described above, a method and apparatus for managing DRM rights objects according to the present invention may provide one or more of the following advantages.

A device, which does not support the DRM technology, can be accessed using a UPnP network, and a DRM rights object can be downloaded to the device.

In addition, DRM rights objects can be managed by determining the validity of the DRM rights objects downloaded to the device, which does not support the DRM technology, and deleting the DRM rights objects if the DRM rights objects are invalid.

Even if a browser, a DRM agent, and a download agent are not implemented in each device on a UPnP network, the devices can access each other and download necessary rights objects. Therefore, an increase in the cost of implementing the devices can be prevented.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method of managing digital rights management (DRM) rights objects, the method comprising:
requesting a media server, which has downloaded specified content, to provide meta information of the content;
determining whether to download a rights object for the content based on the meta information of the content;
requesting an approval for the download of the rights object and downloading the rights object if it is determined to download the rights object; and
providing the downloaded rights object to the media server.

2. The method of claim 1, wherein the providing of the downloaded rights object to the media server comprises:
transmitting a uniform resource identifier (URI) of the downloaded rights object to the media server to enable the media server to download the rights object using the URI.

3. The method of claim 1, further comprising checking a validity of a specified rights object provided to the media server.

4. The method of claim 3, wherein the checking the validity of the rights object provided to the media server comprises:
requesting the media server to provide meta information of a specified rights object;
determining the validity of the rights object based on the meta information of the rights object; and
deleting the rights object if the rights object is determined to be invalid.

5. The method of claim 1, wherein the media server does not support DRM technology.

6. An apparatus for managing digital rights management (DRM) rights objects, the apparatus comprising:
a meta information request unit which requests a media server, which has downloaded specified content, to provide meta information of the content;
a determination unit which determines whether to download a rights object for the content based on the meta information of the content; and
a rights object managing unit which downloads the rights object from a rights issuer when the determination unit determines to download the rights object, and provides the downloaded rights object to the media server.

7. The apparatus of claim 6, wherein the rights object managing unit transmits a uniform resource identifier (URI) of the downloaded rights object to the media server to enable the media server to download the rights object from the apparatus using the URI.

8. The apparatus of claim 6, wherein the determination unit checks a validity of a specified rights object provided to the media server.

9. The apparatus of claim 8, wherein the determination unit checks the validity of the specified rights object, which is provided to the media server, based on meta information of the specified rights object received from the media server after the meta information request unit requested the media server to provide the meta information of the specified rights object.

10. The apparatus of claim 6, wherein the media server does not support DRM technology.
